(19) United States
(12) Patent Application Publication
(10) Pub. No.: US 2010/0033419 A1
(43) Pub. Date: Feb. 11, 2010

(54) LIQUID CRYSTAL DISPLAY WITH COLUMN INVERSION DRIVING METHOD

(75) Inventor: Chun-An Lin, Yunlin County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: CHUNGHWA PICTURE TUBES, LTD., Taoyuan (TW)

(21) Appl. No.: 12/242,833

(22) Filed: Sep. 30, 2008

(30) Foreign Application Priority Data
Aug. 7, 2008 (TW) 97130107

(51) Int. Cl. G09G 3/36

(52) U.S. Cl. 345/100

(57) ABSTRACT

A liquid crystal display (LCD) with a column inversion driving method is provided. The LCD with the column inversion driving method includes a first data line, a second data line, and a first switch. The first switch is electrically connected to the first data line and the second data line. The first data line is adjacent to the second data line. When the LCD with the column inversion driving method is turned off, the first switch is turned on for conducting the first data line and the second data line, so as to neutralize the charges remained in pixels.

### CROSS-REFERENCE TO RELATED APPLICATION

This application claims the priority benefit of Taiwan application serial no. 97130107, filed on Aug. 7, 2008. The entirety of the above-mentioned patent application is hereby incorporated by reference herein and made a part of this specification.

### BACKGROUND OF THE INVENTION

1. Field of the Invention

The present invention generally relates to a liquid crystal display (LCD), in particular, to a LCD with a column inversion driving method capable of eliminating turning-off afterimages.

2. Description of Related Art

Recently, liquid crystal displays (LCDs) have been widely used to replace cathode ray tube (CRT) displays. With the improvement of semiconductor technology, due to the advantages of low power consumption, being thin and light, high resolution, high color saturation, and long service life, LCDs have been widely used in electronic products for daily life, such as a liquid crystal screen of a notebook computer or a desktop computer and an LCD TV.

As notebook computers or other portable mobile products have limited battery power, in the consideration of saving energy, more and more notebook computers adopt a column inversion driving manner to prolong the working time of the electronic products.

Currently, most solutions for eliminating turning-off afterimages are mainly designed for dot-inversion LCDs, but cannot be directly used in the column-inversion LCDs. When the LCD with a column inversion driving method is turned off, as charges stored in the pixel on the same data line have the same polarity, the charges stored in the pixel cannot be dissipated rapidly. Therefore, the LCD with the column inversion driving method looks like turning from white to black like wave tide, that is, afterimage phenomenon occurs, which is called as an undesired wave tide.

### SUMMARY OF THE INVENTION

Accordingly, the present invention is directed to an LCD with a column inversion driving method. When the LCD is turned off, charges on a pixel span across data lines for charge sharing, so as to dissipate the charges rapidly, thereby reducing the undesired wave tide phenomenon.

Accordingly, the present invention provides an LCD with a column inversion driving method, which includes K data lines, a plurality of switches, and a signal line, in which K is a positive integer. Each switch has a control terminal, a first terminal, and a second terminal respectively. The first terminal of the i^{th} switch is electrically connected to the 2i^{th} data line, and the second terminal of the i^{th} switch is electrically connected to the (2i-1)^{th} data line, in which i is a positive integer greater than 0 and less than or equal to K/2. The signal line is electrically connected to the control terminal of the switches for controlling the switches. When the LCD with the column inversion driving method is turned off, the signal line is enabled to turn on the switches.

In an embodiment of the present invention, when the LCD with the column inversion driving method is turned on, the signal line turns off the switches with a low-potential signal, that is, the signal line is disabled to turn off the switches.

In an embodiment of the present invention, the switches are located in a dummy pixel area. The dummy pixel area is disposed at a front-end area or a back-end area of the data line.

In an embodiment of the present invention, the signal line is controlled by a reset IC in the LCD with the column inversion driving method.

In an embodiment of the present invention, the LCD with the column inversion driving method further includes a plurality of scan lines. When the LCD with the column inversion driving method is turned off, the scan lines are enabled.

In an embodiment of the present invention, the switches are thin film transistors (TFTs).

In order to achieve the above objective, the present invention further provides an LCD panel with a column inversion driving method, which includes a first data line, a second data line, and a first switch. The first switch is electrically connected to the first data line and the second data line. The first data line is neighbouring to the second data line, and when the LCD panel with the column inversion driving method is turned off, the first switch is turned on for electrically connecting the first data line and the second data line.

In an embodiment of the present invention, the LCD panel with the column inversion driving method further includes a third data line, a fourth data line, and a second switch. The second switch is electrically connected to the third data line and the fourth data line. The third data line is neighbouring to the fourth data line, and when the LCD panel with the column inversion driving method is turned off, the second switch is turned on for electrically connecting the third data line and the fourth data line.

In an embodiment of the present invention, the LCD panel with the column inversion driving method further includes a plurality of scan lines. When the LCD with the column inversion driving method is turned off, the scan lines are enabled.

In an embodiment of the present invention, the switches are thin film transistors (TFTs).

In view of the above, the present invention disposes switches between neighbouring data lines, and when the LCD with the column inversion driving method is turned off, the reset IC sends out a signal to enable the scan lines and the switches electrically connected between two neighbouring data lines, so as to neutralize charges remained in pixels. As the neighbouring data lines in the LCD with the column inversion driving method have opposite polarities, the present invention can accelerate the dissipation of the charges remained in the pixels, so as to avoid the turning-off afterimage.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic view of a polarity of a display panel with column inversion in the prior art.

FIG. 2 is a schematic view of an LCD according to an embodiment of the present invention.

### DESCRIPTION OF THE EMBODIMENTS

Reference will now be made in detail to the present embodiments of the invention, examples of which are illustrated in the accompanying drawings. Wherever possible, the same reference numbers are used in the drawings and the description to refer to the same or like parts.

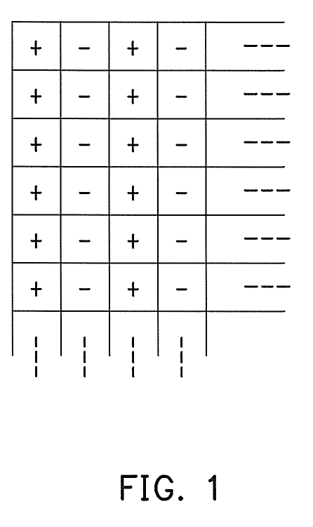

FIG. 1 is a schematic view of a polarity of a display panel with a column inversion in the prior art. Referring to FIG. 1, each grid represents the polarity of a pixel electrode, and a pixel polarity of each column represents a driving polarity of a data line. As known from FIG. 1 that, the same data lines have the same pixel driving polarities and the adjacent data lines have opposite pixel driving polarities.

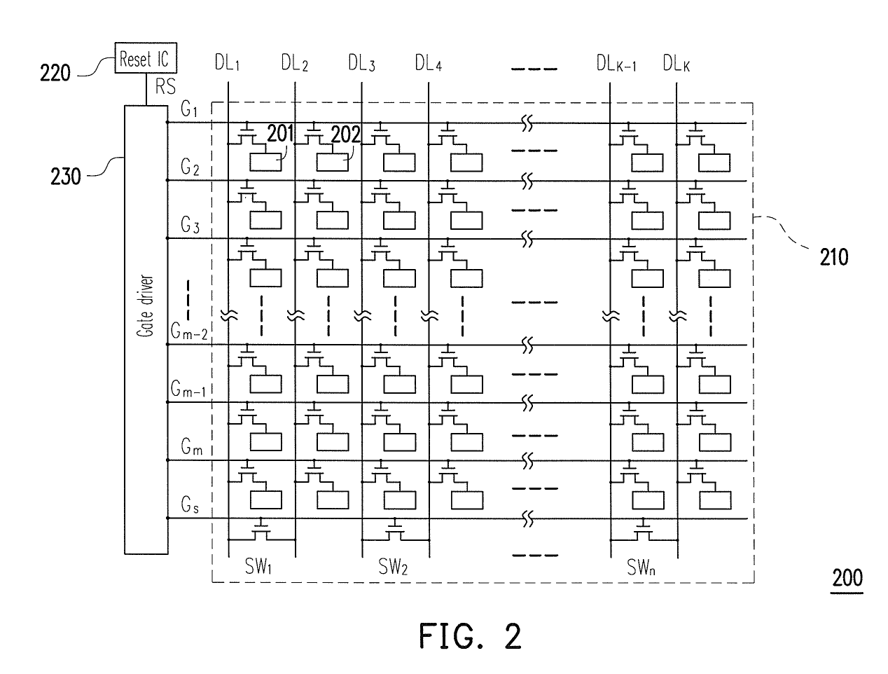

FIG. 2 is a schematic view of an LCD according to an embodiment of the present invention. Referring to FIG. 2, an LCD with a column inversion driving method (called a display for short) 200 includes an LCD panel 210 with a column inversion driving method, a reset IC 220, and a gate driver 230. The LCD panel 210 with the column inversion driving method includes K data lines (K is a positive integer) DL₁-DL_{K}, a signal line Gs, m scan lines (m is a positive integer) G₁-Gₘ, and a plurality of switches SW₁-SWₙ. The switches SW₁-SWₙ are coupled between the adjacent data lines DL₁-DL_{K} respectively and are controlled by the signal line Gs. The switches SW₁-SWₙ are, for example, thin film transistors (TFTs). Each of the switches SW₁-SWₙ has a control terminal (for example, a gate), a first terminal (for example, a source or a drain), and a second terminal (for example, a drain or a source). The first terminal of the i^{th} switch is electrically connected to the (2i-1)^{th} data line, and the second terminal thereof is electrically connected to the 2i^{th} data line, in which i is a positive integer greater than 0 and less than or equal to K/2. The configuration manners of the switches SW₁-SWₙ are as shown in FIG. 2, which will not be described herein again.

In this embodiment, when the display 200 is turned off, the reset IC 220 sends out a signal RS to the gate driver 230 to enable all the scan lines G₁-Gₘ and the signal line Gs. At this time, all the pixels (including pixels 201 and 202) of the LCD panel 210 with the column inversion driving method are turned on, and the switches SW₁-SWₙ are also turned on. Each of the data lines DL₁-DL_{K} is conducted to another adjacent data line through a corresponding switch SW₁-SWₙ. Since the adjacent data lines have opposite driving polarities, the dissipation of the charges remained in the pixels (pixel capacitors and liquid crystal capacitors) is accelerated. For example, when the i^{th} switch SWᵢ is turned on, the pixel charges stored on the 2i^{th} data line DL₂ᵢ are neutralized by the pixel charges on the (2i-1)^{th} data line DL₂ᵢ₋₁ through the switch SWᵢ.

In view of the above, during the normal usage of the display 200, the switches SW₁-SWₙ are turned off, and the data lines DL₁ and DL₂ are not communicated with each other and the display 200 works normally without being affected by the switches SW₁-SWₙ. When the display 200 is turned off, the reset IC sends out a signal RS to the gate driver 230 to enable all the scan lines G₁-Gₘ and the signal line Gs. At this time, all the pixels and the switches SW₁-SWₙ of the LCD panel 210 with column inversion driving method are enabled, and thus the pixel charges on the data line DL₁-DL_{K} are neutralized by the pixel charges on the adjacent data line through the switches SW₁-SWₙ, so as to accelerate the dissipation of the charges remained in the pixels, thereby avoiding the turning-off afterimage.

Furthermore, it should be noted that, the switches SW₁-SWₙ may be disposed in a dummy pixel area around the LCD panel 210 with the column inversion driving method, for example, the front-end area or the back-end area of the data line. The disposing positions of the switches SW₁-SWₙ are not limited in this embodiment, as long as the disposing positions of the switches SW₁-SWₙ, do not affect the layout area of the pixel array. The elements of the switches SW₁-SWₙ are not limited to TFTs, and other types of switch elements may also be adopted depending upon the practical demands.

According to the present invention, the charges remained in the pixels are dissipated rapidly in the charge sharing manner by conducting the data lines with opposite polarities through switches, thereby avoiding the turning-off afterimage and eliminating the wave tide phenomenon.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A liquid crystal display (LCD) with a column inversion driving method, comprising:
K data lines, wherein K is a positive integer;
a plurality of switches, wherein each of the plurality of switches comprises a control terminal, a first terminal, and a second terminal respectively, the first terminal of the i^{th} switch is electrically connected to the 2i^{th} data line, the second terminal of the i^{th} switch is electrically connected to the (2i-1)^{th} data line, and i is a positive integer greater than 0 and less than or equal to K/2; and
a signal line, electrically connected to the control terminals of the switches, for controlling the switches;
wherein when the LCD with the column inversion driving method is turned off, the signal line is enabled to turn on the switches.

2. The LCD with a column inversion driving method according to claim 1, wherein when the LCD with the column inversion driving method is turned on, the signal line is disabled to turn off the switches.

3. The LCD with a column inversion driving method according to claim 1, wherein the switches are located in a dummy pixel area.

4. The LCD with a column inversion driving method according to claim 3, wherein the dummy pixel area is disposed at a front-end area or a back-end area of the data line.

5. The LCD with a column inversion driving method according to claim 1, wherein the signal line is controlled by a reset IC in the LCD with the column inversion driving method.

6. The LCD with a column inversion driving method according to claim 5, further comprising: a plurality of scan lines, wherein when the LCD with the column inversion driving method is turned off, the scan lines are enabled.

7. The LCD with a column inversion driving method according to claim 1, wherein the switches are thin film transistors (TFTs).

8. A liquid crystal display (LCD) panel with a column inversion driving method, comprising:
a first data line;
a second data line; and
a first switch, electrically connected to the first data line and the second data line;
wherein the first data line is adjacent to the second data line, and when the LCD panel with the column inversion driving method is turned off, the first switch is turned on for electrically connecting the first data line and the second data line.

9. The LCD panel with a column inversion driving method according to claim 8, further comprising:
a third data line;
a fourth data line; and
a second switch, electrically connected to the third data line and the fourth data line;
wherein the third data line is adjacent to the fourth data line, and when the LCD panel with the column inversion driving method is turned off, the second switch is turned on for electrically connecting the third data line and the fourth data line.

10. The LCD panel with a column inversion driving method according to claim 8, further comprising: a plurality of scan lines, wherein when the LCD with the column inversion driving method is turned off, the scan lines are enabled.

11. The LCD panel with a column inversion driving method according to claim 8, wherein the first switch is a thin film transistor (TFT).
